(19) United States
(12) Patent Application Publication
(10) Pub. No.: US 2011/0157900 A1
(43) Pub. Date: Jun. 30, 2011

(54) Recessed lighting light bulb cover

(76) Inventor: Ross Garner, San Diego, CA (US)

(21) Appl. No.: 12/286,889

(22) Filed: Dec. 27, 2008

(51) Int. Cl. F21V 5/04; F21V 5/00

(52) U.S. Cl. 362/351

(57) ABSTRACT

A light cover for obscuring light bulbs in recessed lighting fixtures so as to enable the use of far less expensive incandescent light bulbs, or the more energy efficient Compact Fluorescent Lights, (CFLs), instead of the standard flood light style bulb configuration, while maintaining acceptable esthetic appeal. Cover is sized to fit within the baffle of a recessed lighting fixture, and can mount to fixture either frictionally, by a hooking system, or screwing directly to the interior baffle wall. For the frictional or hook mounting systems, covers can be installed or removed without tools, simply by holding the edge surface of the cover and pushing up, into place, or pulling down to remove. Translucent lens can be fabricated out of glass, metal grid or mesh, or other heat tolerant material that allows sufficient light transmission.

### BACKGROUND OF INVENTION

A translucent cover for light bulbs in recessed lighting fixtures, which has various means of attaching said cover, either to the baffle of the lighting fixture, or directly to the bulb itself. This cover consists of a translucent lens fastened to a lens trim which is held in place between the bulb & the baffle trim, or ceiling, by a retaining apparatus. Not only can recessed lights utilizing these lens covers be more attractive than existing flood light style bulbs, but significant savings will be realized by using far less expensive common incandescent bulbs, or the energy efficient tubular neon bulbs instead of the floodlight style bulb typically used in recessed lights.

The aesthetically attractive feature comes from the twofold ability to choose not only the trim color, finish, or texture to match the room motif; but the lens itself can also be varied in color, texture or finish. For instance, the trim surrounding the lens could be antique bronze, stainless steel, brush nickel, or any number of colors, while the lens could be frosted, pebbled, etched, patterned, alabaster, etc., to tie into the decor of the room, or other light fixtures, such as chandeliers, sconces, table or floor lamps.

Although the aesthetic appeal of these covers is a significant benefit on it's own, the greater motivation for purchasing these covers comes from the substantial savings when considering the difference in price between floodlight style light bulbs versus common incandescent, or the energy efficient neon style light bulbs. Common style incandescent bulbs sell for approximately $3.00 to $4.00 for a package of six bulbs, or less than seventy-five cents each. Like wise, energy efficient neon style light bulbs can be purchased for approximately $1.00 each. Contrasted to common floodlight style bulbs, which cost usually between $3.00 to $7.00 per bulb, or more, and the potential savings is very significant indeed. These considerable savings will translate equally well, & be readily realized, for either residential or commercial applications. Although these covers will vary in cost, dependent on the style &/or uniqueness of the lens trim or lens itself, being able to lower the average cost of acceptable bulbs by an expected three to six dollars, per bulb, will quickly cover the one time cost of the lens covers themselves. In addition, the energy savings from using the neon style bulb can be realized immediately, by not having to purchase the recently introduced neon style floodlight bulbs, which currently cost $8.00 or more, again, per bulb.

An expected counter point to be made in defense of the flood light style bulbs will be the downward directional beam flood light style bulbs offer. While these covers are not intended to replace floodlight style bulbs, they will offer another option for the consumer, that many will find provides a perfectly acceptable lighting alternative. However, for those wishing to have the best of all worlds, conical reflectors are already available that can screw in behind either type of less expensive bulb, which can be used in conjunction with these covers to provide a more downward directional light pattern, similar to standard floodlight patterns.

Another beneficial feature of these lens covers is that the temperature effects of recessed lighting fixtures can often cause the lights to turn off if the temperature raises to an unacceptable level. This is more often caused with sealed covers, which are most common for recessed lighting shower fixture trims. The proposed lighting covers allow for approximately the same open space presently afforded between existing baffles & flood light bulbs, however the size of common incandescent bulbs are much smaller than flood light style bulbs, thereby offering considerably more free flowing air space up in the fixture area itself, which translates to greater cooling ability than with flood light style bulbs.

### PATENT SEARCH & PRIOR ART

USPTO Patent Agent, (name & agent # withheld), was employed to do a Patent Search with respect to this item, which encompassed searching databases for the United States, Europe, and Japan. Although many patents were reviewed which did incorporate lens covers within their recessed lighting fixture, none were found to be for either the same purpose or application, contained far more working parts, would not be nearly as easy to install or remove, and would be far more costly to manufacture than the proposed embodiment. Specifically;

Patent Application Pub. No.: US2007/0183154A1—Sealed Cover for Recessed Lighting. This invention is for a sealed cover, as described in it's title, and is meant for the purpose of retaining heat in the winter, cool air in the summer, while also providing a means for preventing insects to invade the living space. Although this was the closest patent our search turned up, it raises temperature shut off issues, seals tight to the ceiling, and is for an entirely different purpose than the invention submitted herein. (Inventor Name: C. Mark Robson)

U.S. Pat. Nos.; 4,746,840 - 4,745,533 - 6,457,848 - 6,168,299 - 5,720,548 - 5,400,231 all contain lens covers, but are far more complex, much more expensive to manufacture, also employ relatively sealed lenses, and are for completely different applications & purposes.

### BRIEF DESCRIPTION OF THE DRAWINGS

FIG. 1 is an interior perspective looking down, at the back side of the light cover showing a possible version of the retention system attached to the lens trim. These workings fit up into the recessed light fixture, around the bulb, which centers the lens under the bulb, concentric with the baffle and baffle trim. The retention system allows for setting the lens level with &/or on the same plane as the ceiling, or at various parallel planes up into the baffle, closer to the bulb.

FIG. 2 is another interior perspective looking at the embodiment from the side, showing the light cover in place, and frictionally supported by the upper rim of the baffle. In this view the cover is on the approximate same plane as the baffle trim, which sets flush to the ceiling, with adjustment settings for raising or lowering the cover apparent.

FIG. 3 is a lower perspective, looking up at the ceiling. The light cover is in place in the embodiment of the recessed light fixture, obscuring the bulb. The white ring, represents open space between the baffle trim & lens cover, which allows for adequate ventilation necessary to keep a hot bulb from raising temperatures to a detrimental level, which can shorten bulb life or cause the fixture temperature sensor to turn the light off.

FIG. 4 is a side interior perspective, showing a variation using the same lens cover but supported by a retention system which frictionally attaches to the actual bulb. The retention system can be made of metal, or other heat tolerant material, which is can be pushed onto and constricts around the bulb, with a pressure adequate to hold the lightweight cover in place, but not such that it would cause breakage upon installation or removal. This version is dependent on the type of bulb utilized, either the common incandescent as shown in this figure, or the energy efficient neon bulb type, as shown in FIG. 5. The method of raising & lowering the cover plane incorporates, but is not limited to, the threaded adjuster shown in FIG. 1.

FIG. 5 shows a side interior perspective with a variation of the retention system adapted to suit the shape of the energy efficient neon bulb. Another variation would attach to the vertical tube style bulb, and could be easily fashioned & obvious to one skilled in the art. Other shapes and configurations for affixing to the bulb are possible and could be made and incorporated by one skilled in the art.

FIG. 6 shows a side sectional view of the plane of the lens & lens trim. Item 12 shows an optional raised feature that helps to obscure the line of sight up into the fixture, bulb or retention system, for a person looking up into the fixture from the floor level. This is strictly for aesthetic purposes, and as illustrated does not serve any necessary functional purpose. This lip could, however, also be used to provide surfaces to connect the retention system to the cover, rather than attaching to the back of the actual lens trim, which may be considered a more optimal surface for such purpose, as it would not be as readily visible from below, and therefore eliminate the need for a plate to attach fittings to in order to prevent cosmetic imperfections seen from below.

FIG. 7 shows another possible version the lens cover & trim which is an all-in-one molded lens that has holes on the top, non-visible from below side. Clips, retaining rims, or other means of attachment obvious to one skilled in the art, could be utilized for connecting the retention system to the cover. This version eliminates the need for separate glass, trim & tabs, and could be made of translucent glass, plastic, or other heat tolerant polymer. This could be a more economical, less complicated option to manufacture, and therefore could be priced less than the separate lens & separate trim assembly, but may not offer quite as many aesthetic options as the separate trim & lens version. Nevertheless, it would accomplish the same purpose, and needs—to be considered as an alternative bulb cover to be offered.

FIG. 8 shows one possible method for affixing the retention system to the lens trim. There are many different variations for accomplishing this purpose, obvious to one skilled in the art, to incorporate, but unnecessary to elaborate every possibility. One possibility not shown but worth mention, however, would be a separate upper plate or rim which the trim would attach to. Such a rim, or plate, could be fitted with the necessary means for affixing the retention system in place, but would allow for a more cosmetic, economical, or practical purpose, rather than trying to make the trim, which is visual from below, be an all-in-one piece, though that would be possible. Dimples or other imperfections caused from manufacturing methods for punching or stamping tabs, loops, etc., would not be desirable from an aesthetic standpoint.

FIG. 9 shows a bendable tab, representing one method, but not limited to this method, for holding the lens in place. These tabs are shown throughout many of the figures, as are many of the items expounded on in the Detailed Description of Invention section, and are one of many different means of holding such a lens in place known to one skilled in the art.

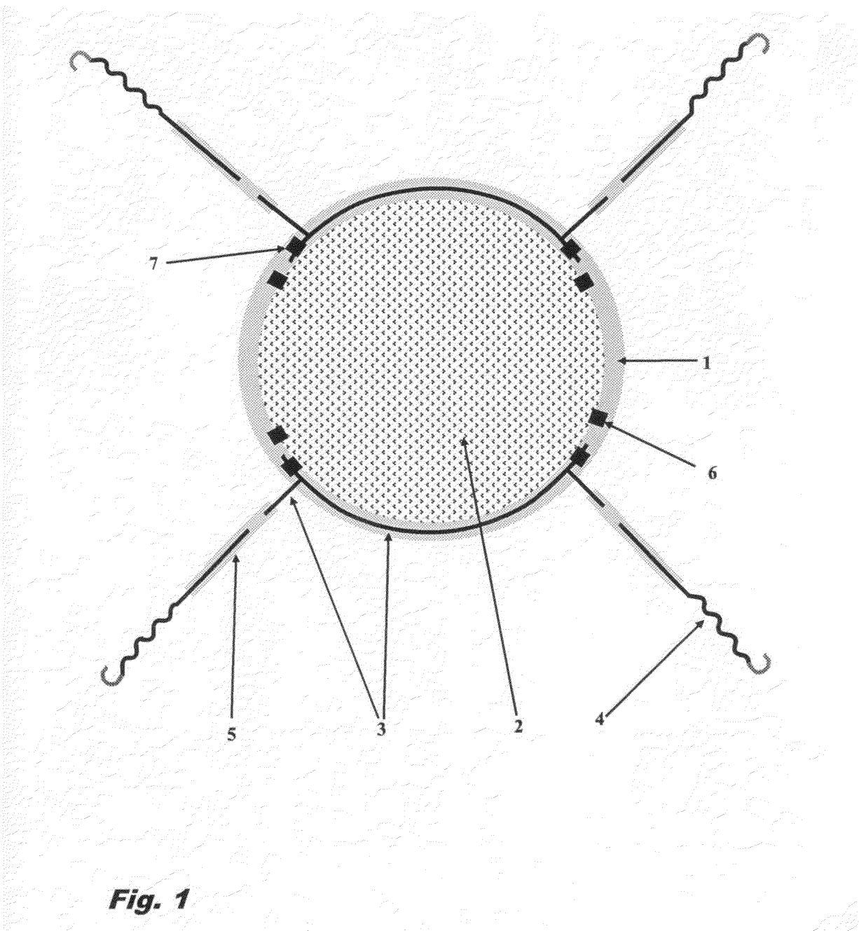

### DETAILED DESCRIPTION OF INVENTION

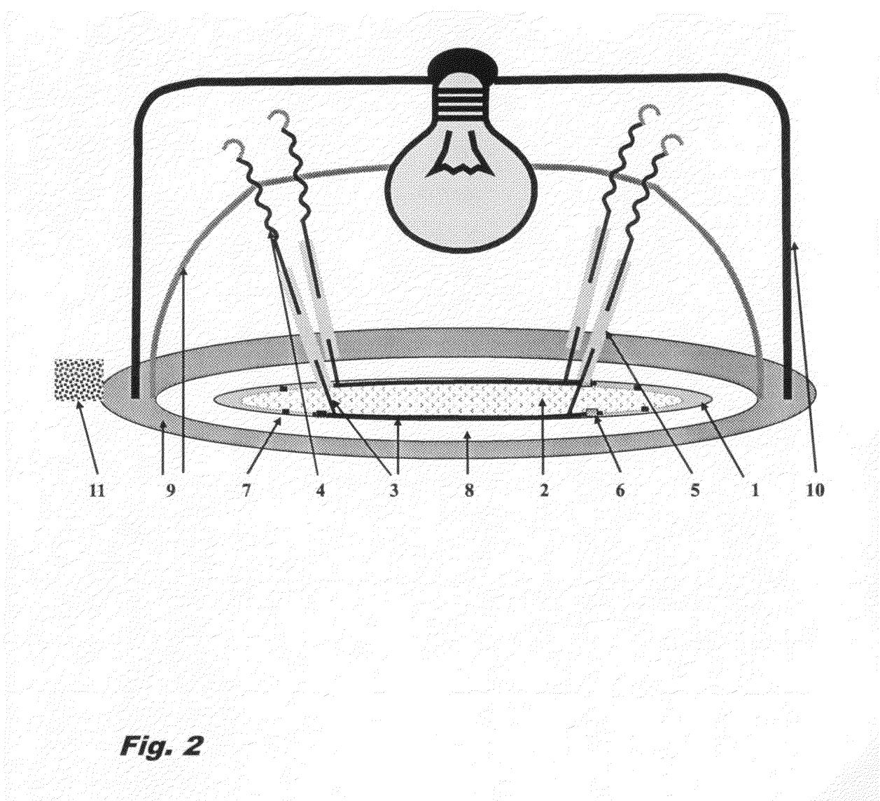

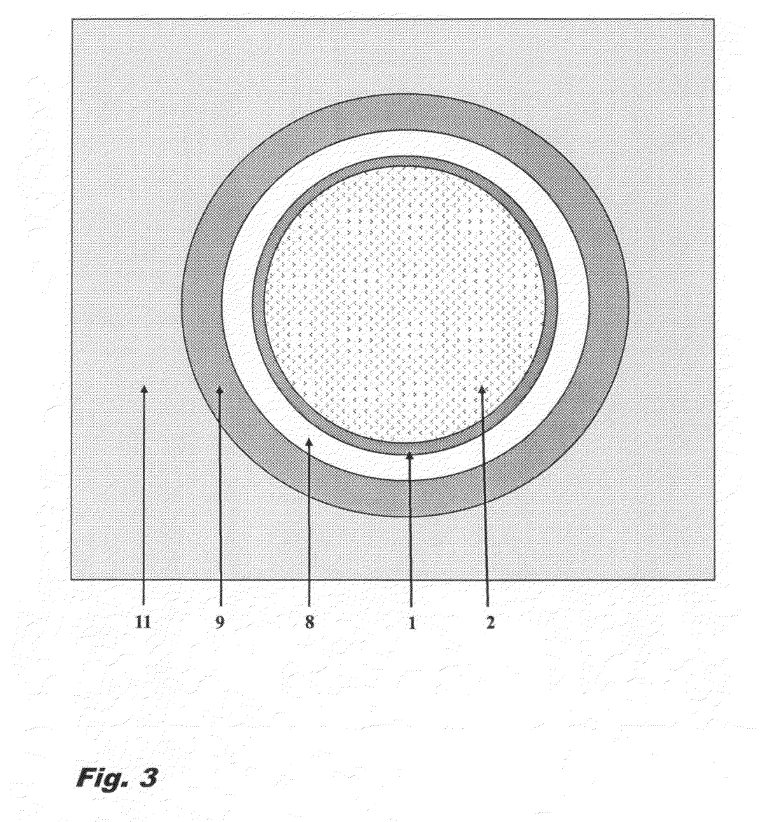

FIG. 2 shows the bulb cover in place, and in this perspective is flush with the ceiling baffle trim. The lens trim (1), could be made of metal, plastic, or other heat tolerant polymer, and could be offered in any number of colors, finishes, and textures. The width of the trim (1) could be varied considerably, from the thinnest trim (1) which still maintains a safe utilitarian purpose, to a wider rim that offers more cosmetically distinctive options. Although the lens cover is illustrated as a circle, this item could easily be manufactured in any number of shapes & sizes to match available recessed lighting fixture shapes.

Round recessed lighting fixtures are the most common type shape of fixture, which is what was illustrated, but is not intended to be limited to this shape. In addition, round fixtures are typically offered in 6″, 4″, & 3″ diameters, which would likely be the most widely used sizes offered & requested, but the features & benefits of this invention are not limited by size or shape restrictions, from much larger warehouse possible uses to smaller accent light applications.

The lens (2) aligns over the top of the trim (1), and can be kept in place by any number of attachment methods available in the industry & known to one skilled in the art of design & manufacture. Bendable tabs (7), are shown in FIG. 8 as one method to hold such a lens in place, but the manner of affixing said lens may be accomplished by many other means as well.

The translucent lens (2) itself, can also be offered in many different types of mediums, to include, but not limited to glass, plastic, metal, or heat tolerant polymer, as well as possible grates or light diffusing grills. A wide range of colors, textures, patterns, etchings, or other design modifications to vary the appearance, attractiveness, or uniqueness of the lens could be offered.

The retention system (3) for holding the cover in place has many possibilities, with the one depicted made of a rigid wire which can be configured in a shape that offers a spring effect to facilitate appropriate opposing outward frictional pressure against the top rim of the trim baffle (9). This allows for easily pushing the cover up to the desired height upon installation, or pulling the cover down & out for removal. The method of height adjustment shown in FIG. 2 is accomplished through a series of bends in the wire that frictionally line up with the upper rim of the trim baffle. However, the means of supporting the lens could be accomplished by a system of straight rods and screw adjustments for height variations as well. Though a rod and screw type of assembly could accomplish the retention purpose, & is not meant to be excluded, it is considered to be a heavier, less economically preferred method of attachment, & therefore not included in these drawings, though such an assembly would be obvious to one skilled in the art.

In addition the lens cover could easily be attached to the sides of the baffle with a more horizontal, visible connector & screw configuration, at the approximate level of the lens, either up inside the baffle (9) area, or flush to ceiling level, thereby eliminating the need for the extensions up to the bulb or upper baffle rim. However, this method was evaluated & discounted, as possible, but not preferable as it is not as quick & easy to insert & attach, nor would it be as aesthetically unobtrusive. The present embodiment retention—suspension system offers a means to quickly & easily install, or remove, the cover without the need for any tools, and greatly reduces the visible means for holding the cover in place. This ‘floating’ effect is much more in line with the current appearance of open space around existing screw-in type flood lamp shaped bulbs typically used in common recessed lighting, but which is believed to be equal to, if not more visually appealing than commonly used flood lamp type bulbs.

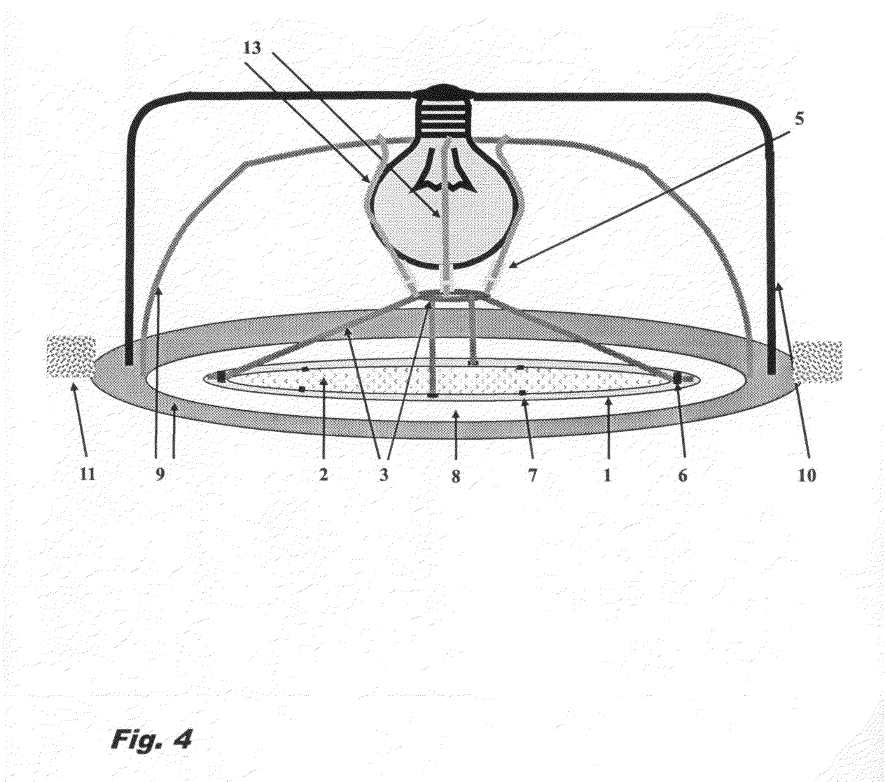

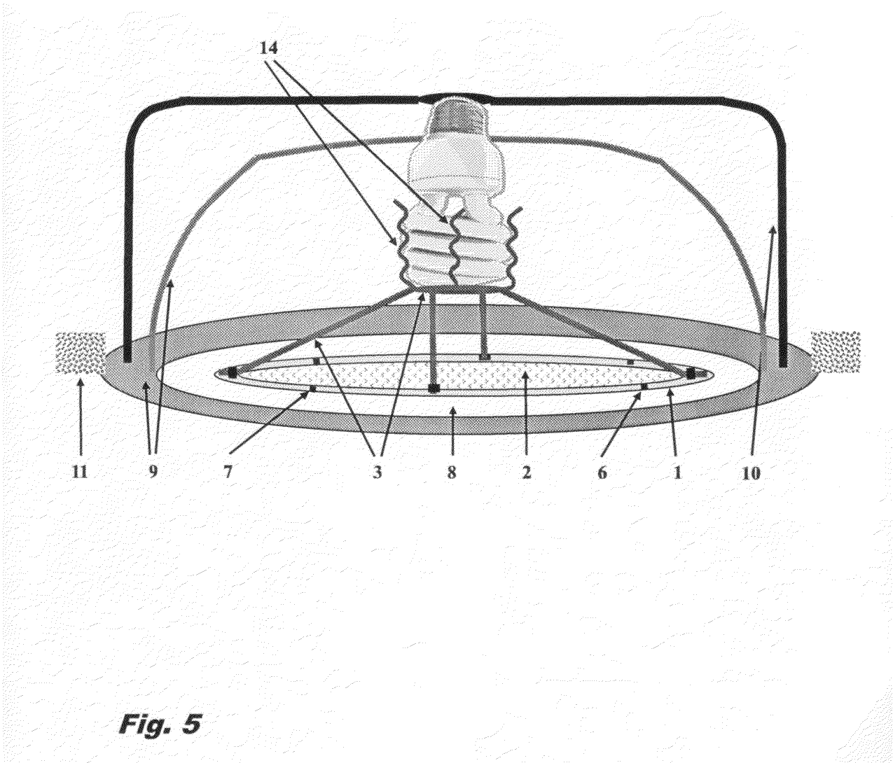

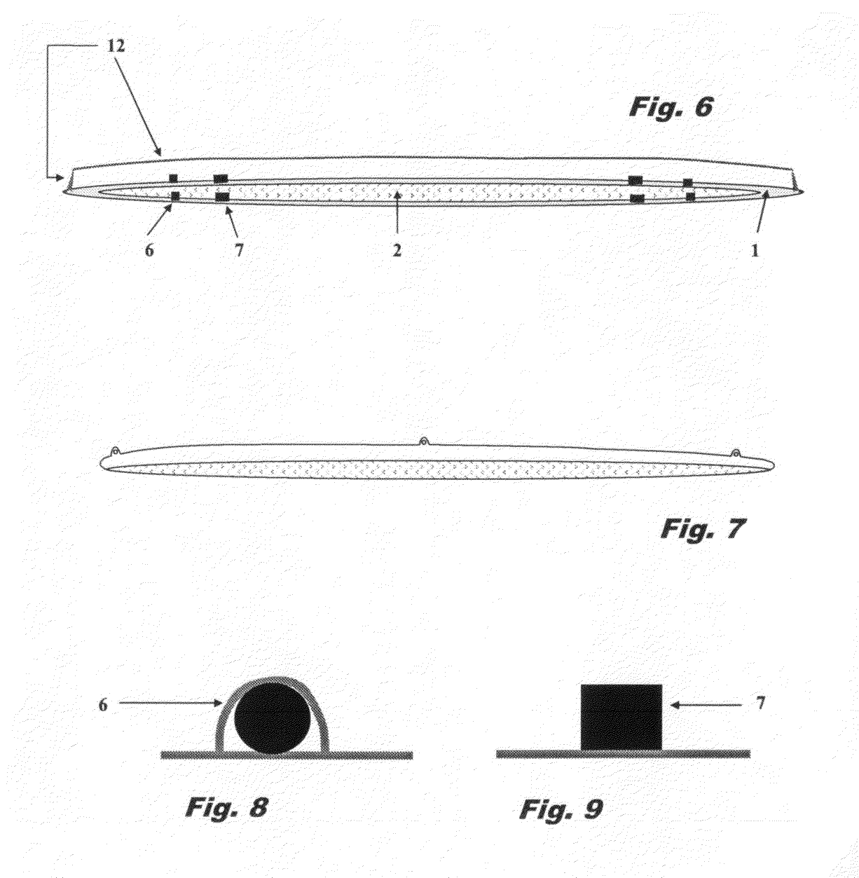

The retention system shown also offers a further adjustment feature, depicted by (5) solid or tubular connector, which is threaded down the center. This connects the lens cover to the suspension apparatus, and offers additional means to adjust the depth of the lens cover within the baffle (9) area void, below the light bulb. Either the bended ridged wire (4), adjustable connector, or both could be utilized as a means of setting the height of the lens cover. Other means of attaching or the adjusting the lens cover within the baffle area, obvious or apparent to one skilled in the art could be incorporated, and are not meant to be excluded from consideration. FIG. 4 & FIG. 5 depict other such methods of holding the cover in place.

Although relatively rigid wire has been offered as a material to accomplish the objective of suspension, plastic, or other suitably heat resistant polymer rod, or strips could be utilized for this purpose, and are not intended to be excluded from consideration to accomplish a variant method of suspension. The drawings reflect four spines (4) attaching to the upper baffle rim (9), or to the bulb directly in FIG. 4 & FIG. 5. This same purpose could be accomplished using three such spines in all three configurations shown, which may ultimately be deemed adequate & preferred. The retention objective is clear, however, & not intended to be limited to this method, or number of spines alone.

Item #7 is a loop, depicted in FIG. 8, on the backside of the lens trim (1) which offers a port for the wire at the base of the retention apparatus (3) to attach to the trim (1). One skilled in the art could provide many other methods for affixing the retention system to the trim, some of which could be a lip on the edge of the trim (1) rolled over the wire base, or plate rim attached to the trim (1). A flat inset plate rim would provide a means of reducing cosmetic imperfections visible from floor level below. Such a rim plate is not shown, nor are many other manners of affixing the retention apparatus, which would be apparent to one skilled in the art.

A flexible hook, clip, or retaining device, at the end of the ridged retainer spine (4), is one possible safety measure for catching the lens should the retention system lose enough of it's frictional pressure to cause the lens to slide downward. This hook would catch the upper rim of the baffle (9), and stop the cover from lowering further. This hook would have to be more flexible than the main spine (4) it attaches to so that it would not complicate removal, but rigid enough to catch on the baffle trim (9). This hook could be made out of metal, plastic, or some other suitable material, and be threaded to screw onto the spine (4), or otherwise attached to end of said spine (4). Such a hook is an optional safety measure, which is not expected to be necessary, given the light weight of the cover, but is a feature that could offer a more perceptual rather than actual value to both the consumer, retailer, & manufacturer.

1) A translucent, or semi-translucent lens, or grid, for light bulbs in recessed lighting fixtures, of a type having a baffle which holds a light bulb receptacle and an outer trim surrounding the baffle that is generally flush with the ceiling; the bulb cover comprising; a lens sized to fit within the baffle, inside the outer rim of the recessed lighting fixture; a retaining system attached to the lens that frictionally engages the light cover to the baffle, or directly to the bulb itself, which partially or fully obscures the direct visibility of the actual light bulb from below, wherein the lens may be gripped at the edges to engage by pushing the mounting flange up into the baffle, or onto the bulb direct, to secure the lens to the recessed lighting fixture and when disengaging, by pulling the retaining system from the baffle, or bulb itself, to remove the lens from the recessed lighting fixture.

2) The lens cover of claim 1 wherein the actual lens, or grid, is made of heat tolerant glass, heat resistant polymer, or type of metal, or alloy, which obscures direct viewing of the bulb from below.

3) The lens of claim 1 to be either flat, concave or convex to the bulb within the baffle.

4) The lens of claim 1 to be held in place by means of an outer rim attached to the lens for the purpose of attaching the retaining apparatus to, which then frictionally attaches to the baffle, or bulb directly, or hooks over the upper inside ridge of the baffle.

5) The outer rim of claim 4 to be constructed in such a shape as to allow the lens to be moved within the baffle, either flush to the ceiling, or recessed further up within the baffle, with said rim to be of the approximate same shape as the baffle at the ceiling level, (most likely round, but could be square, rectangular, etc.).

6) The outer rim of claim 4 to be constructed of metal, heat tolerant polymer, or other heat tolerant rigid material to provide adequate support to the lens, with a means of attaching a retention system to hold the lens in the center of the baffle.

7) The outer edge of rim of claim 4 to be held in place approximately ¼″ to ½″ from the baffle itself in order to allow for ventilation above the lens so as maintain an acceptably low temperature of the airspace surrounding the light bulb.

8) The mounting flange of claim 1 includes a plurality of spines, or protrusions, equally spaced & attached to the lens, or lens rim of claim 1, which allows to the lens to frictionally attach to the baffle.

9) The spines of claim 8 to have a portion of their length notched, or bent, so as to provide a means for maintaining the lens at numerous, level, settings within the baffle, equal to the plane of the ceiling, or up within the baffle, closer to the bulb.

10) The spines of claim 8 can have an optional safety hook at the end of each spine that provides a means of hooking, or catching over the upper rim of the baffle, to prevent the lens apparatus from falling, should the frictional quality of the spines ever become inadequate to hold the apparatus in place.

11) The spines of claim 8 can also have the optional hook on the upper end of the spine also be the primary means of retaining the apparatus in place, as they hook over the upper edge of the baffle.

12) The spines of claim 8 can also have a threaded sleeve between the upper hook & the point of attachment to the outer rim of claim 1, as another means for altering the position of the lens height within the baffle between the ceiling level & the lower tip of the light bulb.

13) The spines of claim 8 can also be of a shape to frictionally grip to either a common A-Type incandescent bulb, or the energy efficient Compact Fluorescent Light, (CFL), bulb, and although this is a possible means of retention, it is not considered to be the preferred method for a number of reasons, including, but not limited to the potential for breakage during placement or removal, as well as different shapes of bulbs, and the desirability to maintain the lens at a level plane with the ceiling.
